(19) United States
(12) Patent Application Publication
(10) Pub. No.: US 2024/0232831 A1
(43) Pub. Date: Jul. 11, 2024

(54) METHOD AND SYSTEM FOR MANAGING LIQUIDITY REQUIREMENTS IN PAYMENT SYSTEM

(71) Applicant: Financial Network Analytics LTD, London (GB)

(72) Inventors: Kimmo Soramaki, London (GB); Samantha Cook, London (GB)

(21) Appl. No.: 18/152,792

(22) Filed: Jan. 11, 2023

(51) Int. Cl. G06Q 20/10; G06Q 20/40

(52) U.S. Cl. CPC G06Q 20/10; G06Q 20/4016

(57) ABSTRACT

Disclosed is a method for managing liquidity requirements in payment system, the method comprising: receiving transaction data comprising plurality of transactions in payment system, first order for plurality of transactions, and specifications of plurality of transactions, wherein specification of transaction includes sender(s), receiver(s), and value of said transaction; determining available liquidities of participants plurality of transactions, each participant being sender or receiver in transaction(s); determining second order in which plurality of transactions are to be settled, based on values of plurality of transactions and available liquidities of their senders, wherein liquidity requirements for settling plurality of transactions using second order are lesser than liquidity requirements for settling plurality of transactions using first order; reordering plurality of transactions prior to settlement such that upon said reordering, plurality of transactions are arranged in second order, wherein plurality of transactions are settled according to second order, for liquidity savings, by fund transfer system.

### TECHNICAL FIELD

This invention relates to payment system. In particular, this invention relates to a method for managing liquidity requirements in a payment system. This invention also relates to a system for managing liquidity requirements.

### BACKGROUND

Financial institutions play an important role in financial system and economy of a country. Virtually all economic activities are facilitated by transfers of funds by the financial institutions. As one example, in 2020, an annual value of interbank payments made using a Pan-European system (for example, TARGET2) was over 722 trillion euro. As another example, an annual value of interbank payments using Fedwire system in United States was 990 trillion dollars which is nearly forty times its annual GDP. Apart from the payment systems mentioned above, financial institutions operate their own internal payment systems. All these payments systems must function efficiently in order to maintain global economy. Efficiency of the payment systems depends upon liquidity. Reducing an amount of liquidity required for payment systems to operate, increases efficiency and/or stability in the payment systems.

One of the widely used approaches to minimize liquidity requirements is multilateral netting of transactions. However, the multilateral netting has various disadvantages associated with it. Firstly, in this approach, a netting agent is required to calculate each participant's net position, receive payments from those who owe money, and to make payments to those who are owed money. Involvement of the netting agent significantly increases operational cost and/or legal cost of payments.

Secondly, multilateral netting requires novation to substitute counterparties in a payment contract and ensuring that the necessary contracts are in place and maintained for all participants require a significant effort from all participants, which is difficult to achieve.

Moreover, large value payment systems use a variety of algorithms to construct netting sets, i.e., to find a set of transactions that can be bilaterally or multilaterally netted subject to participants' liquidity constraints and other risk controls. For example, Clearing House Interbank Payments System (CHIPS) in the United States, Clearing House Automated Payments System (CHAPS) in the United Kingdom, and Lynx in Canada all use complex algorithms that find sets of payments to be netted. However, all these aforesaid payment systems require the netting agent to implement the settlement of transactions selected by these algorithms. Dependency on the netting agent to settle the transactions, in addition to choosing the set of transactions significantly increases a time duration required to settle the transactions. Further, dynamic programming and other algorithms have been considered, but are found to be computationally not feasible for a very high number of payments since they require substantial computing time.

Therefore, considering the foregoing discussion, there exists a need to overcome the aforementioned drawbacks associated with existing solutions employed for managing liquidity requirements in payment systems.

### SUMMARY OF THE INVENTION

A first aspect of the invention provides a method for managing liquidity requirements in a payment system, the method comprising:
receiving transaction data comprising
a plurality of transactions in the payment system,
a first order for the plurality of transactions, and
specifications of the plurality of transactions, wherein a specification of a transaction includes at least a sender, at least a receiver, and a value of said transaction;
determining available liquidities of participants in the plurality of transactions, each participant being a sender or a receiver in at least one transaction amongst the plurality of transactions;
determining a second order in which the plurality of transactions is to be settled, based at least on values of the plurality of transactions and available liquidities of their senders, wherein liquidity requirements for settling the plurality of transactions using the second order are lesser than liquidity requirements for settling the plurality of transactions using the first order; and
reordering the plurality of transactions prior to settlement such that upon said reordering, the plurality of transactions is arranged in the second order, wherein the plurality of transactions is settled according to the second order, for liquidity savings, by a fund transfer system.

The “liquidity” refers to funding that financial institutions use to settle the plurality of transactions. The funding is a combination of balance and overdraft protection. The term “financial institution” refers to a facility engaged in financial and monetary transactions. Examples of the financial institution could be, but are not limited to, a commercial bank, an investment bank, a brokerage firm, and similar. The “liquidity requirements” relate to an overall amount of liquidity needed by the payment system to facilitate settlement of the plurality of transactions, in the payment system. The plurality of transactions in the payment system are managed to minimize the liquidity requirements for settling the plurality of transactions. For example, the reordering of the plurality of transactions yields liquidity requirements similar or near similar to the liquidity requirements obtained from multilateral netting. The liquidity requirements are managed to ensure uninterrupted settlement of the plurality of transactions in the payment system and to increase efficiency and stability in the payment system. Stability in the payment system is a necessary factor to efficiently run overall economy. It will be appreciated that the multilateral netting is well known in the art.

The transaction data is received in the payment system from a data source. Examples of the data source could be, a data repository, a cloud server, devices associated with the participant, and the like. The payment system may be implemented as at least one software application. The at least one software application could be a single software application or a plurality of software applications. The at least one software application helps to receive the transaction data. It will be appreciated that the payment system and the fund transfer system are associated with each other to receive the transaction data and settle the plurality of transactions. Optionally, the fund transfer system is a part of the payment system. Further, it will be noted that receiving the plurality of transactions refers to recording information of the plurality of transactions.

The term “order” refers to a sequence in which the plurality of transactions is received or settled in the payment system. Herein, the “first order” signifies the sequence in which the plurality of transactions is received in the payment system. The plurality of transactions may encompass a number of the plurality of transactions received on a given day. As a first example, the number of the plurality of transactions in the payment system may be eight (for the sake of simplicity only), arranged in the first order, for example, T1, T2, T3, T4, T5, T6, T7, and T8.

In one example, the term “sender” refers to a sending financial institution which is entitled to pay the value of said transaction. In an example, the “receiver” refers to a receiving financial institution which is entitled to receive the value of said transaction. In the method, upon receiving the transaction data, the available liquidities of the participants involved in the plurality of transactions is determined. The available liquidities of the participants are balances plus overdraft limits available with senders or receivers of the plurality of transactions. The available liquidities of the participants are determined to establish whether the plurality of transactions can be settled or not. It will be noted that, the available liquidities are determined only for those participants who are involved in the at least one transaction as the sender or the receiver. There may be one or more participants who are not involved in any transaction amongst the plurality of transactions. System participants that are not involved in any transactions do not require any liquidity, or in other words, it can be understood that the liquidity requirements of such participants that are not involved in any transactions is always equal to zero. For example, there may be 100 participants in the payment system. Amongst 100 participants 60 participants may be involved in 50 transactions, thus, the available liquidities are determined only for 60 participants. Therefore, a complete set of system participants might not be represented in a given set of transactions. In an example, for a given set of transactions there may be some system participants who do not appear as the sender or receiver of any payment, since it is not a requirement of the method that all system participants are either a sender or receiver of at least one transaction of the plurality of transactions.

Optionally, the step of determining the available liquidities of the participants in the plurality of transactions comprises:
determining whether the transaction data comprises liquidity information, wherein the liquidity information pertains to the available liquidities of the participants in the payment system;
when it is determined that the transaction data comprises the liquidity information, assigning the available liquidities of the participants based on the liquidity information;
when it is determined that the transaction data excludes the liquidity information, determining net positions of the participants based on the specifications of the plurality of transactions, wherein a net position of a participant is equal to a total value of transactions received by the participant minus a total value of transactions sent by the participant; and
assigning the available liquidities of the participants, based on the net positions of the participants,

wherein when the net position of the participant is positive or zero, an available liquidity of the participant is assigned to be equal to zero, and when the net position of the participant is negative, an available liquidity of the participant is assigned to be equal to an absolute value of the net position.

Optionally the liquidity information is available in the transaction data. It will be appreciated that the transaction data may include other information, such as the liquidity information in addition to the plurality of transactions, the first order, and the specification of the plurality of transactions. In such cases, the liquidity information may be used to determine the available liquidity of the given participant.

Alternatively, in other cases, the transaction data may exclude the liquidity information. In such cases, the available liquidities of the participants are calculated by determining the net positions of the participants. The “net position” of a financial institution is equal to total value of transactions received by the financial institution minus total value of transactions sent by the financial institution. For example, the financial institution may have the total value of transactions received equal to 11 million, and the total value of transactions sent equal to 10 million. Thus, the net position of the financial institutions may be 1 million.

The “net position” may also be referred to as “net cumulative position”. A net position of a participant in the payment system may vary with time. The net position of the participant may be varied in a manner that it could be positive, zero, or negative at a given time instant. A sum of absolute value of negative net positions of financial institutions represents the liquidity requirements in the payment system. The net positions of the participants at end-of-time represents the liquidity required to settle the plurality of transactions at once via the multilateral netting.

The net position of the participant is positive, when the total value of the transactions received by the participant is greater than the total value of the transaction sent by the participant.

The net position of the participant is zero, when the total value of the transaction received by the participant is equal to the total value of the transaction sent by the participant. In a case, when the net position of the participant is positive or zero, the available liquidity is assigned to be as a minimum value, i.e., zero.

The net position of the participant is negative, when the total value of the transaction received by the participant is less than the total value of the transaction sent by the participant. In said case, when the net position of the participant is negative, the available liquidity is assigned to be as the absolute value of the net position. It is understood that the absolute value may have a minimum magnitude. It will be understood that, in said case, the available liquidity is assigned as the absolute value only, as a negative magnitude of the available liquidity represents a condition, in which it would be impossible to settle any transaction of the participant.

Further, in the method, upon determining the available liquidities of the participants, the plurality of transactions in the transaction data are re-arranged in the second order. The term “second order” specifies the order in which the plurality of transactions is to be settled. A computing time required for determining the second order may be approximately linear in terms of a number of transactions. This means that using the method, even extremely large sets of transactions can be reordered (and subsequently settled) in a reasonable amount of time.

The plurality of transactions received in the first order are re-arranged in such a manner as the liquidity requirements for settling the plurality of transactions is significantly reduced. Advantageously, the available liquidities of the participants involved in the plurality of transactions are determined accurately to settle the plurality of transactions efficiently, resulting in imparting stability to the payment system.

Optionally, the step of determining the second order in which the plurality of transactions is to be settled comprises:
selecting a given transaction, such selection being performed according the first order by going from a first transaction in the first order to a last transaction in the first order;
determining feasibility of settlement of the given transaction by at least comparing a value of the given transaction with an available liquidity of a sender of the given transaction;
when the value of the given transaction is less than or equal to the available liquidity of the sender, determining that the given transaction can be settled using the available liquidity and adding the given transaction to the second order; and
when the value of the given transaction is greater than the available liquidity of the sender, determining that the given transaction cannot be settled using the available liquidity and adding the given transaction to a pending transaction queue of the sender.

In this regard, the plurality of transactions (arranged in the first order) are selected one by one starting from the first transaction to the last transaction. The feasibility of the given transaction is determined by comparing values of the available liquidity of the sender associated with the given transaction with the value of the given transaction. The available liquidity and the value of transaction may be compared to establishing whether the sender has enough balance to pay the value of the transaction to the receiver (associated with the given transaction), or not. In a case, when it is determined that the value of the given transaction is less than the available liquidity of the sender, it means that the sender will be able to pay the value of the given transaction to the receiver. In said case, the given transaction is added to the second order.

Next, when it is determined that the value of the given transaction is greater than the available liquidity, it means that the sender will be unable to pay the value of the given transaction, to the receiver. In said case, the given transaction is moved to the pending transaction queue of the sender. The phrase “pending transaction queue” refers to data structure in which transaction(s) is/are held pending by the sender or by the payment system in a certain order to prevent any limits set against the sender from being breached or to manage the liquidity requirements efficiently. Optionally, the given transaction which is added to the pending transaction queue of the sender will be settled when the sender has the available liquidity (i.e., balance plus overdraft) greater than the value of the given transaction.

Referring to the first example, the plurality of transactions arranged in the first order, i.e., T1, T2, T3, T4, T5, T6, T7 and T8 may be selected one by one starting from T1 to T8. Further, the feasibility of settlement of each transaction is determined from T1 to T8. When determining the feasibility of the transaction T1, it may be observed that the value of the transaction T1 is lower than the available liquidity of the sender of T1, therefore, the transaction T1 may be added to the second order. Next, it may be observed that the value of the transaction T2 is greater than the available liquidity of the sender of T2, therefore, the transaction T2 may be added to the pending transaction queue of its sender. Similarly, the comparison is performed for all the transactions, i.e., T3, T4, T5, T6, T7 and T8. At the end of such comparison, the second order may be T1, T3, T4, T5. Rest of the transactions i.e., T2, T6, T7, T8 may be added to the pending transaction queues of their senders, therefore are not shown in the second order.

Notably, the plurality of transactions is settled by the fund transfer system. The fund transfer system may be a Real Time Gross Settlement (RTGS) system. The “RTGS system” is the fund transfer system that allows for an instantaneous transfer of money and/or securities. The RTGS is a continuous process of settling the plurality of transactions on an individual order basis without netting the plurality of transactions. Optionally, the plurality of transactions in the second order are settled one by one, for the liquidity savings using the RTGS system.

Advantageously, in the method of the present disclosure, the plurality of transactions is re-ordered from the first order to the second order, to enable in efficient liquidity management in the payment system. By “efficient liquidity management”, it is meant that management of liquidity requirements is performed by the method and the system in a manner that liquidity requirements are minimized (for example, the liquidity requirements are often as low as achieved by multilateral netting) and computations required for minimizing the liquidity requirements are performed in a time-efficient manner and by not overburdening computing resources. More beneficially, the method relies on simple and elegant calculations, which are computationally feasible and can be implemented in a time efficient manner. Hundreds of millions of transactions may be processed by the method in a very short time. For example, the method may process five hundred thousand transactions within a time period of 1 to 2 minutes. Further, reordering of the plurality of transactions leads to substantial liquidity savings while settling the plurality of transactions gross, without any netting, and thus efficiently eliminating costs associated with the netting while the liquidity benefits are realized. For example, owing to absence of novation or the netting agent, the costs associated with creating and/or maintaining contracts required for the novation and the netting are eliminated, and additional settlement infrastructure or legal entanglements are not required. The plurality of transactions can be processed without any operational and/or legal costs associated with the multilateral netting.

Optionally, the transaction data further comprises at least one of: dates of the plurality of transactions, times of the plurality of transactions, transaction constraints and/or risk controls, and wherein the step of determining the feasibility of settlement of the given transaction is performed by also determining whether the given transaction complies with the transaction constraints and/or risk controls, wherein when the given transaction complies with the transaction constraints and/or risk controls, it is determined that the given transaction can be settled and the given transaction is added to the second order. Advantageously, the technical effect of this is that an amount of information required for settlement of the plurality of transaction is increased, which significantly enhances efficiency and/or stability in the payment system. In this regard, the transaction data also comprises the dates and the times on which the plurality of transactions are to be settled. The plurality of transactions is received in a chronological order in the payment system based on the dates and the times of the plurality of transactions. Optionally, the transaction constraints and/or risk controls comprise at least one of: bilateral limits of the transactions, multilateral limits of the transactions, priorities of the transactions, account pooling information of participants of the transactions. In this regard, in addition to comparing the value of the given transaction with the available liquidity of the sender, the feasibility of settlement of the given transaction is established upon satisfying the aforesaid transaction constraints and/or risk controls.

When it is determined that the given transaction can be settled, the method may further comprise:
updating an available liquidity of a receiver of the given transaction by adding the value of the given transaction to the available liquidity of the receiver;
checking a pending transaction queue of the receiver of the given transaction to determine whether there exist one or more transactions in said pending transaction queue, wherein the receiver of the given transaction is the sender for the one or more transactions;
when it is determined that there exist the one or more transactions in said pending transaction queue, for the one or more transactions in said pending transaction queue, comparing a value of the one or more transactions with the updated available liquidity;
when the value of one of the one or more transactions is less than or equal to the updated available liquidity, determining that said transaction can be settled using the updated available liquidity and adding said transaction to the second order.

In this regard, upon determining that the given transaction can be settled, the value of the given transaction is added to the available liquidity of the receiver. Addition of the value of the given transaction to the available liquidity increases the available liquidity of the receiver to the updated available liquidity.

Next, the pending transaction queue of the receiver may be checked to determine presence of the one or more transactions, for which the receiver is the sender. The feasibility of the one or more transactions is determined by comparing the values of the one or more transactions with the updated available liquidity. Upon determining that the one of the one or more transactions can be settled using the updated available liquidity, said transaction is added to the second order. Advantageously, the technical effect of this is that the transactions of all the senders in the payment system can be addressed, thereby maintaining stability in the payment system. Continuing the above example, after it is determined that T5 can be settled and upon its settling (which will happen later), the liquidity of the receiver of T5 will increase. When the receiver of T5 has a pending transaction queue in which transaction T2 is present, then T2 is checked for settlement. When a value of T2 is less than the updated available liquidity of the sender of T2, it is determined that T2 can be settled, and thus, T2 is added to the second order. Next, when it is determined that T2 can be settled and upon its settling (which will happen later), the liquidity of receiver of T2 will increase. When the receiver of T2 has a pending transaction queue in which T7 is present, then the T7 is checked for settlement. When a value of T7 is less than the updated available liquidity of the sender of T7, it is determined that T7 can be settled and thus, T7 is added to the second order. In said example, the plurality of transactions may be arranged in the second order, as T1, T3, T4, T5, T2 and T7.

When it is determined that the given transaction can be settled, the method further comprises updating an available liquidity of the sender of the given transaction by subtracting the value of the given transaction from the available liquidity of the sender.

When it is determined that the value of the one of the one or more transactions is less than or equal to the updated available liquidity, the method further comprises updating the updated available liquidity by reducing the value of said transaction from the updated available liquidity. In other words, when it is determined that the said transaction can be settled, the updated available liquidity of the receiver is reduced. The value of the one or more transactions is reduced from the updated available liquidity. For example, upon receiving a value of at least one transaction, the updated available liquidity of the financial institution may increase to 40 million from zero. In said example, upon checking the pending transaction queue of the financial institution, there may be one transaction, having a value equal to 20 million, required to be settled.

Thus, the transaction of 20 million may be settled and thus the updated available liquidity may remain to be 20 million.

Optionally, the method further comprises adding any transactions existing in pending transaction queues of their senders, to the second order, according to positions of said transactions in the first order. In this regard, any transactions existing in the pending transaction queues of their senders are the transactions which are not added to the second order, owing to their values greater than the available liquidities of their senders. When it is determined that the transactions just cannot be settled unless their senders' liquidity increases, i.e., when they continue to stay in their senders' pending transaction queues, they can still be added to the second order. Optionally, the transactions in the senders' pending transaction queues are added to second order, upon analyzing all the transactions present in the transaction data. The transactions may be added in the second order in the same order in which they were received, i.e., the first order. In case their sender's liquidity increases (for example, by the payment system increasing their overdraft limits, by receiving payment(s)), these transactions can be settled according to their positions in the second order, and therefore all the transactions belonging to the transaction data can be completed while reducing the liquidity requirements in comparison to existing systems. Continuing the above example, the transactions may be checked in the first order, i.e., from T1-T8, upon checking all the transactions, T6 and T8 may be present in their sender's pending transaction queues. Therefore, said transactions, T6 and T8 may be added to the second order in the same order as they are received in the payment system. The second order of the plurality of transactions may be T1, T3, T4, T5, T2, T7, T6 and T8, which is different from first order.

When the plurality of transactions comprises at least one recurring transaction, the method further comprises updating the first order prior to the step of determining the second order in which the plurality of transactions is to be settled, by moving the at least one recurring transaction towards a beginning of the first order. The “recurring transaction” is a transaction that repeats on a periodic basis. The at least one recurring transaction are known to financial institution well before they are due. The recurring transactions may be moved towards the beginning of the first order to efficiently and easily manage the liquidity requirements needed to settle these traditionally. The at least one recurring transaction comprises a single transaction or multiple transactions. The at least one recurring transaction is moved towards the beginning of the first order to enable an early settlement of the at least one recurring transaction. For example, the at least one recurring transaction may be settled at a start of a day or at a fixed time in the day. When the at least one recurring transaction comprises the single transaction, the single transaction is moved towards the beginning of the first order. When the at least one recurring transaction comprises the multiple transactions, the multiple transactions are moved towards the beginning of the first order. Advantageously, an earlier settlement of the at least one recurring transaction may result in a reduction of the liquidity requirements. A reduction of liquidity requirement in combination with eliminating the requirement of a netting agent result in a more efficient payment system with a decrease in the total time for completion of the payment. Since in the present payment system and method, payments are settled directly between the sending and receiving counterparties, there is no need for additional settlement computing infrastructure and thus settlements can be completed with less computing power than existing solutions involving a netting agent.

Optionally, the method is implemented at a plurality of time instants in a time period to enable transaction settlement in a batch-wise manner, and wherein the transaction data corresponding to a given implementation of the method at a given time instant pertains to at least one of: one or more transactions that are submitted for settlement in a time duration between a previous time instant at which a previous implementation of the method is performed and the given time instant, one or more transactions that are unsettled at an end of a previous implementation of the method. Advantageously, the technical effect of enabling transaction settlement in the batch-wise manner is that the plurality of transactions can be effectively analyzed in small batches and settled, thereby reducing delay in payment settlement.

In this regard, the plurality of time instants could be any number of time instants in a whole day. A number of the time instants may depend upon a number of the plurality of transactions. For example, higher the number of transactions received in the payment system, higher may be a number of time instants in the whole day. As one example, the whole day may be divided into four-time instants separated at the time period of six hours. In said example, the plurality of transactions received at the time period of 6 hours are analyzed (as discussed above) and arranged in the second order, to enable settlement.

In one implementation, the transaction data at the given instant may comprise the one more transactions received between the previous time instant and the given time instant. In this regard, the previous time instant and the given time instant may be varied by a specific time period. For example, the method may be implemented after a time period of 3 hours. In said example, transaction data received at a batch corresponding to 3 PM time instant, may comprise the plurality of transactions received between a time period of three hours from 12 PM to 3 PM. In another implementation, the transaction data may comprise the one or more transactions that remained unsettled at the end of the previous time instant and the one or more transactions that are received between the previous time instant and the given time instant. In this regard, the transaction data comprises the plurality of transactions that may have remained unsettled at the end of the previous time instants and the plurality of transactions received between the previous time instant and the given time instant. Continuing the above example, the transaction data may comprise the plurality of transactions that are received at a batch corresponding to 6 PM time instant, may comprise the plurality of transactions not settled between 12 PM to 3 PM and the plurality of transactions received between 3 PM to 6 PM.

Optionally, the payment system is a large-value payment system (LVPS), wherein LVPS is a contractual and operational arrangement between parties (for example financial institutions) to transfer relatively large-values to each other (for example, hundreds of thousands, millions, billions of a given currency) wherein the transfers of funds are time-critical. In this regard, the LVPS is the payment system that handles large-value transaction and/or high-priority transactions. When the payment system is a LVPS, the method further comprises providing an incentive to senders of transactions that are submitted for settlement during a predefined time period in a day. The transactions may be submitted in the payment system for settlement overnight. Optionally, the transactions are reordered in the second order to settle transactions in early hours of the day. For example, the transactions may be settled during first 12 hours of the day. Reordering the transactions such that they can be settled during early hours of the day significantly reduces the liquidity requirements to settle the same. Furthermore, the liquidity-efficient payment system for of the present invention may be an incentive to participants of the LVPS system to submit payments earlier in the day, or as early as possible in the time period set, thus increasing the efficiency of the system. Advantageously, settling the transactions in the predefined time-period results in reduced liquidity requirements and in an uninterrupted settlement of subsequent transactions throughout the day, thus increasing the stability of the payment system and avoiding further delays in payment settlement.

A second aspect of the invention provides a system for managing liquidity requirements in a payment system, the system comprising at least one processor configured to:
receive transaction data comprising a plurality of transactions in the payment system, a first order for the plurality of transactions, and specifications of the plurality of transactions, wherein the specification of a transaction includes at least a sender, a receiver, and a value of said transaction;
determine available liquidities of participants in the plurality of transactions, each participant being a sender or a receiver in at least one transaction amongst the plurality of transactions;
determine a second order in which the plurality of transactions is to be settled, based at least on values of the plurality of transactions and available liquidities of their senders, wherein liquidity requirements for settling the plurality of transactions using the second order are lesser than liquidity requirements for settling the plurality of transactions using the first order; and
reorder the plurality of transactions prior to settlement such that upon said reordering, the plurality of transactions is arranged in the second order, wherein the plurality of transactions is settled according to the second order, for liquidity savings, by a fund transfer system.

The term “processor” refers to a computational element that is operable to respond to and process instructions. Furthermore, the term “processor” may refer to one or more individual processors, processing devices and various elements associated with a processing device that may be shared by other processing devices. Such processors, processing devices and elements may be arranged in various architectures for responding to and executing processing steps. The at least one processor is configured to execute the at least one software application for implementing at least one processing task that the at least one processor is configured for.

The at least one processor may be further configured to send to at least one device executing the fund transfer system, a communication indicative of the second order in which the plurality of transactions are arranged. In this regard, the at least one device may be communicably coupled to the at least one processor via a communication network. Such communication indicative is sent, for example, to settle the plurality of transactions in the second order by the fund transfer system. For example, the communication indicative is sent to the at least one device at the plurality of time instants in the time period to enable settlement of the plurality of transactions in the batch-wise manner. Examples of the device executing the fund transfer could be, but are not limited to a laptop, a desktop. The communication indicative may also pertain to the specifications of the plurality of transactions.

The at least one processor may be communicably coupled to devices of the participants in the payment system, wherein the transaction data is obtained by the at least one processor from said devices. Examples of the devices could be, but are not limited to, a smartphone, a smartwatch, a tablet, a laptop, a desktop. The at least one processor may be communicably coupled to the devices via the communication network. Furthermore, when the at least one processor sends a given information to a given device of a participant, the given information pertains to at least one of: an estimated time of settlement of the given transaction, indication of completion of the given transaction, indication of less available liquidity of a participant (i.e., a sender).

The system may further comprise a data repository communicably coupled to at least the at least one processor, wherein the data repository is configured to store thereat at the transaction data and the second order. The data repository is implemented at a remote memory associated with the system. Examples of the remote memory may include, but are not limited to, a cloud-based memory, a blockchain-based memory, computer-cluster based memory (e.g.: Remote Direct Memory Access memory), and a distributed memory. Alternatively, the data repository is implemented at a local memory associated with the system. Examples of the local memory may include, but are not limited to, a Solid State Drive (SSD) memory (such as a flash memory, a memory stick, a Secure Digital (SD) card, and the like), a hard disk drive (HDD) memory, a floppy disk, a portable compact disc read-only memory (CD-ROM), and a digital versatile disk (DVD). Alternatively, the data repository is implemented in a distributed manner at both the remote memory and the local memory associated with the system. Optionally, the data repository is coupled to the devices of the participants.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires; in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 illustrates steps of a method for managing liquidity requirements in a payment system, in accordance with an embodiment of the present disclosure;

FIG. 2 is an exemplary illustration of how a net position of a participant in a payment system varies with time, in accordance with an embodiment of the present disclosure;

FIG. 3A illustrates an exemplary first order for a plurality of transactions and specifications of the plurality of transactions, FIG. 3B illustrates liquidity requirements for settling the plurality of transactions using the first order of FIG. 3A, FIG. 3C illustrates an exemplary second order in which the plurality of transactions are determined to be settled, and FIG. 3D illustrates liquidity requirements for settling the plurality of transactions using the second order of FIG. 3C, in accordance with an embodiment of the present disclosure; and

FIGS. 4A, 4B, 4C, and 4D illustrate exemplary environments in which a system for managing liquidity requirements in a payment system is in use, in accordance with various embodiments of the present disclosure.

### DETAILED DESCRIPTION

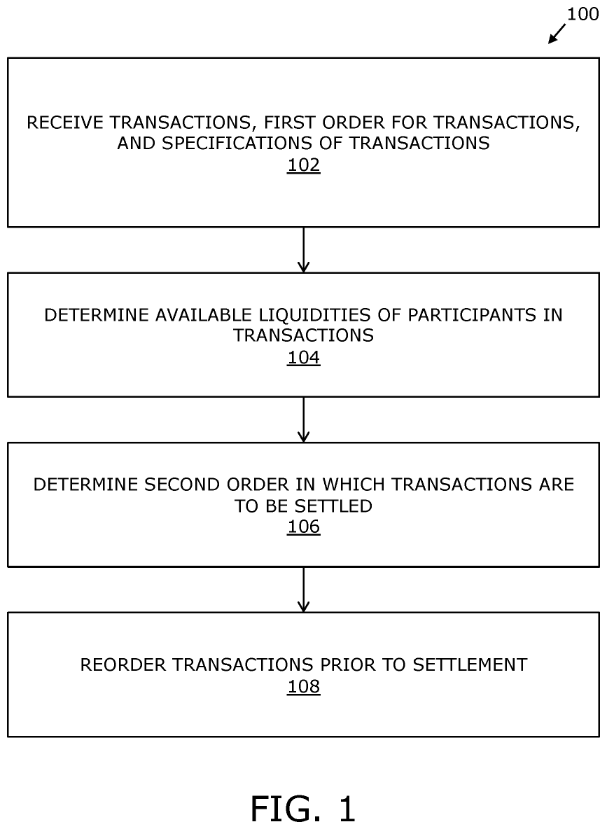

Referring to FIG. 1, illustrated are steps of a method 100 for managing liquidity requirements in a payment system, in accordance with an embodiment of the present disclosure. At 102, there is received transaction data comprising a plurality of transactions in the payment system, a first order for the plurality of transactions and specifications of the plurality of transactions. A specification of a transaction includes at least a sender, a receiver, and a value of said transaction. At 104, available liquidities of participants in the plurality of transactions are determined, each participant being a sender or a receiver in at least one transaction amongst the plurality of transactions. At 106, a second order in which the plurality of transactions is to be settled is determined, based at least on values of the plurality of transactions and available liquidities of their senders, wherein liquidity requirements for settling the plurality of transactions using the second order are lesser than liquidity requirements for settling the plurality of transactions using the first order. At 108, the plurality of transactions is reordered prior to settlement such that upon said reordering, the plurality of transactions is arranged in the second order, wherein the plurality of transactions is settled according to the second order, for liquidity savings, by a fund transfer system.

The aforementioned steps are only illustrative and other alternatives can also be provided where one or more steps are added, one or more steps are removed, or one or more steps are provided in a different sequence without departing from the scope of the claims herein.

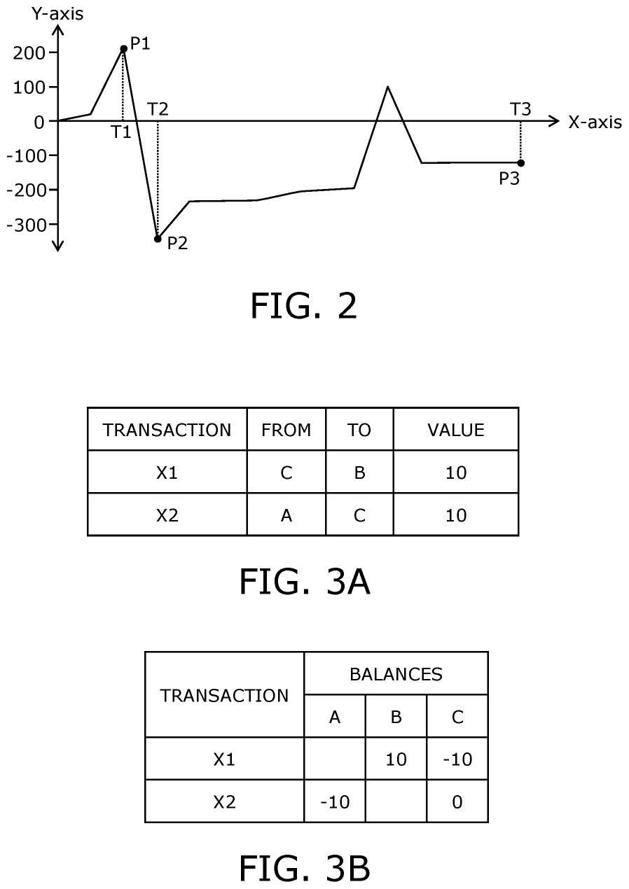

Referring to FIG. 2, illustrated is an exemplary illustration of how a net position of a participant in a payment system varies with time, in accordance with an embodiment of the present disclosure. The net position (in terms of millions of a given currency, for example) is represented on Y-axis whereas the time is represented on X-axis. As shown, the net position of the participant varies in a manner that it could be positive, zero, or negative at a given time instant. The “net position” may also be referred to as “net cumulative position”. In a time period between time instant 0 and a time instant T3: position P1 is a largest positive net cumulative position and the position P1 is achieved at a time instant T1, position P2 is a largest negative net cumulative position (LNNCP) and the position P2 is achieved at a time instant T2, position P3 is indicative of an end-of-time period net cumulative position and the position P3 is achieved at the time instant T3.

FIG. 2 is merely an example, which should not unduly limit the scope of the claims herein. The person skilled in the art will recognize many variations, alternatives, and modifications of embodiments of the present disclosure.

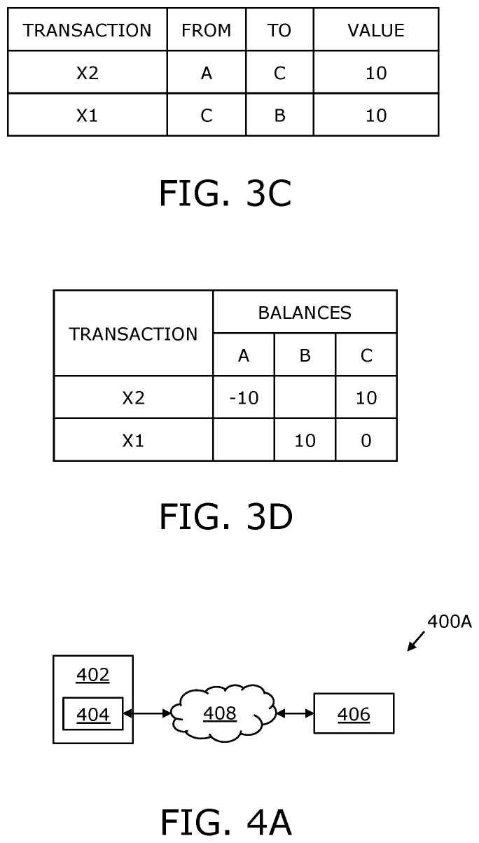

Referring to FIGS. 3A, 3B, 3C, and 3D, FIG. 3A illustrates an exemplary first order for a plurality of transactions and specifications of the plurality of transactions, FIG. 3B illustrates liquidity requirements for settling the plurality of transactions using the first order of FIG. 3A, FIG. 3C illustrates an exemplary second order in which the plurality of transactions are determined to be settled, and FIG. 3D illustrates liquidity requirements for settling the plurality of transactions using the second order of FIG. 3C, in accordance with an embodiment of the present disclosure.

In FIG. 3A, the first order is shown to be: transaction X1, transaction X2, meaning that the transaction X1 occurs before the transaction X2. As shown, C is a sender, B is a receiver, and 10 units is a value of the transaction X1, whereas A is a sender, C is a receiver, and 10 units is a value of the transaction X2.

In FIG. 3B, there are shown balances of participants A, B, and C after each transaction, when the transactions X1 and X2 are settled according to the first order. The liquidity requirements for settling the transactions X1 and X2 using the first order are determined as a sum of negative balances at the end of each transaction, which in this case, is equal to −20.

In FIG. 3C, the second order is shown to be: transaction X2, transaction X1. The second order is determined using a method for managing liquidity requirements in a payment system, based on values of the transactions X1 and X2 and available liquidities of their senders.

In FIG. 3D, there are shown balances of the participants A, B, and C after each transaction, when the transactions X1 and X2 are settled according to the second order. The liquidity requirements for settling the transactions X1 and X2 using the second order are also determined as a sum of negative balances at the end of all transactions, which in this case, is equal to −10. Thus, the liquidity requirements for settling the transactions X1 and X2 using the second order are 50% lesser than the liquidity requirements for settling the transactions X1 and X2 using the first order.

FIGS. 3A-3D are merely examples, which should not unduly limit the scope of the claims herein. The person skilled in the art will recognize many variations, alternatives, and modifications of embodiments of the present disclosure.

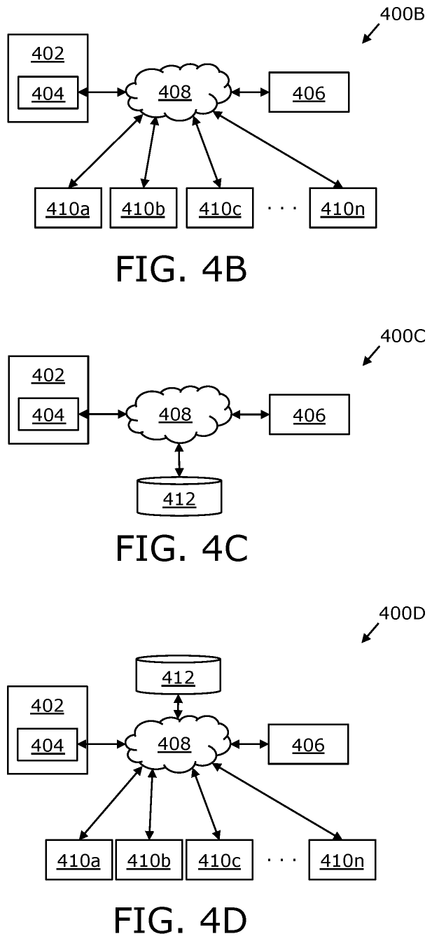

Referring to FIGS. 4A, 4B, 4C, and 4D, illustrated are exemplary environments 400A, 400B, 400C, and 400D, respectively, in which a system 402 for managing liquidity requirements in a payment system is in use, in accordance with various embodiments of the present disclosure. The system 402 comprises at least one processor (depicted as a processor 404).

In FIGS. 4A-4D, the processor 404 is shown to be communicably coupled to at least one device (depicted as a device 406) executing a fund transfer system, via a communication network 408. In FIGS. 4B and 4D, the processor 404 is shown to also be communicably coupled to devices of the participants in the payment system (depicted as devices 410a, 410b, 410c, . . . , 410n of the participants, n being the index, which are collectively referenced as devices 410 for the sake of simplicity only). In FIGS. 4C and 4D, the system 402 is shown to further comprise a data repository 412 which is communicably coupled to at least the processor 404. In FIG. 4D the data repository 412 could also be coupled to the devices 410 of the participants in the payment system.

FIGS. 4A-4D are merely examples, which should not unduly limit the scope of the claims herein. The person skilled in the art will recognize many variations, alternatives, and modifications of embodiments of the present disclosure.

1. A method for managing liquidity requirements in a payment system, the method comprising:
receiving transaction data comprising
a plurality of transactions in the payment system,
a first order for the plurality of transactions, and
specifications of the plurality of transactions, wherein a specification of a transaction includes at least a sender, at least a receiver, and a value of said transaction;
determining available liquidities of participants in the plurality of transactions, each participant being a sender or a receiver in at least one transaction amongst the plurality of transactions;
determining a second order in which the plurality of transactions is to be settled, based at least on values of the plurality of transactions and available liquidities of their senders, wherein liquidity requirements for settling the plurality of transactions using the second order are lesser than liquidity requirements for settling the plurality of transactions using the first order; and
reordering the plurality of transactions prior to settlement such that upon said reordering, the plurality of transactions is arranged in the second order, wherein the plurality of transactions is settled according to the second order, for liquidity savings, by a fund transfer system.

2. A method according to claim 1, wherein the step of determining the second order in which the plurality of transactions is to be settled comprises:
selecting a given transaction, such selection being performed according the first order by going from a first transaction in the first order to a last transaction in the first order;
determining feasibility of settlement of the given transaction by at least comparing a value of the given transaction with an available liquidity of a sender of the given transaction;
when the value of the given transaction is less than or equal to the available liquidity of the sender, determining that the given transaction can be settled using the available liquidity and adding the given transaction to the second order; and
when the value of the given transaction is greater than the available liquidity of the sender, determining that the given transaction cannot be settled using the available liquidity and adding the given transaction to a pending transaction queue of the sender.

3. A method according to claim 2, wherein the transaction data further comprises at least one of: dates of the plurality of transactions, times of the plurality of transactions, transaction constraints and/or risk controls, and wherein the step of determining the feasibility of settlement of the given transaction is performed by also determining whether the given transaction complies with the transaction constraints and/or risk controls, wherein when the given transaction complies with the transaction constraints and/or risk controls, it is determined that the given transaction can be settled and the given transaction is added to the second order.

4. A method according to claim 2, wherein when it is determined that the given transaction can be settled, the method further comprises:
updating an available liquidity of a receiver of the given transaction by adding the value of the given transaction to the available liquidity of the receiver;
checking a pending transaction queue of the receiver of the given transaction to determine whether there exist one or more transactions in said pending transaction queue, wherein the receiver of the given transaction is the sender for the one or more transactions;
when it is determined that there exist the one or more transactions in said pending transaction queue, for the one or more transactions in said pending transaction queue, comparing a value of the one or more transactions with the updated available liquidity;
when the value of one of the one or more transactions is less than or equal to the updated available liquidity, determining that said transaction can be settled using the updated available liquidity and adding said transaction to the second order.

5. A method according to claim 4, wherein when it is determined that the value of the one of the one or more transactions is less than or equal to the updated available liquidity, the method further comprises updating the updated available liquidity by reducing the value of said transaction from the updated available liquidity.

6. A method according to claim 2, further comprising adding any transactions existing in pending transaction queues of their senders, to the second order, according to positions of said transactions in the first order.

7. A method according to claim 1, wherein the step of determining the available liquidities of the participants in the plurality of transactions comprises:
determining whether the transaction data comprises liquidity information, wherein the liquidity information pertains to the available liquidities of the participants in the payment system;
when it is determined that the transaction data comprises the liquidity information, assigning the available liquidities of the participants based on the liquidity information;
when it is determined that the transaction data excludes the liquidity information, determining net positions of the participants based on the specifications of the plurality of transactions, wherein a net position of a participant is equal to a total value of transactions received by the participant minus a total value of transactions sent by the participant; and
assigning the available liquidities of the participants, based on the net positions of the participants,
wherein when the net position of the participant is positive or zero, an available liquidity of the participant is assigned to be equal to zero, and when the net position of the participant is negative, an available liquidity of the participant is assigned to be equal to an absolute value of the net position.

8. A method according to claim 1, wherein when the plurality of transactions comprises at least one recurring transaction, the method further comprises updating the first order prior to the step of determining the second order in which the plurality of transactions is to be settled, by moving the at least one recurring transaction towards a beginning of the first order.

9. A method according to claim 1, wherein the method is implemented at a plurality of time instants in a time period to enable transaction settlement in a batch-wise manner, and wherein the transaction data corresponding to a given implementation of the method at a given time instant pertains to at least one of: one or more transactions that are submitted for settlement in a time duration between a previous time instant at which a previous implementation of the method is performed and the given time instant, one or more transactions that are unsettled at an end of a previous implementation of the method.

10. A method according to claim 1, wherein the payment system is a large-value payment system (LVPS), the method further comprises providing an incentive to senders of transactions that are submitted for settlement during a predefined time period in a day.

11. A method according to claim 1, wherein the fund transfer system is a Real Time Gross Settlement (RTGS) system.

12. A system for managing liquidity requirements in a payment system, the system comprising at least one processor configured to:
receive transaction data comprising a plurality of transactions in the payment system, a first order for the plurality of transactions, and specifications of the plurality of transactions, wherein the specification of a transaction includes at least a sender, a receiver, and a value of said transaction;
determine available liquidities of participants in the plurality of transactions, each participant being a sender or a receiver in at least one transaction amongst the plurality of transactions;
determine a second order in which the plurality of transactions is to be settled, based at least on values of the plurality of transactions and available liquidities of their senders, wherein liquidity requirements for settling the plurality of transactions using the second order are lesser than liquidity requirements for settling the plurality of transactions using the first order; and
reorder the plurality of transactions prior to settlement such that upon said reordering, the plurality of transactions is arranged in the second order, wherein the plurality of transactions is settled according to the second order, for liquidity savings, by a fund transfer system.

13. A system according to claim 12, wherein the at least one processor is further configured to send, to at least one device executing the fund transfer system, a communication indicative of the second order in which the plurality of transactions is arranged.

14. A system according to claim 12, wherein the at least one processor is communicably coupled to devices of the participants in the payment system, wherein the transaction data is obtained by the at least one processor from said devices.

15. A system according to claim 12, wherein the system further comprises a data repository communicably coupled to at least the at least one processor, wherein the data repository is configured to store thereat at the transaction data and the second order.
